(19) United States
(12) Patent Application Publication
(10) Pub. No.: US 2005/0257654 A1
(43) Pub. Date: Nov. 24, 2005

(54) Blade server system

(76) Inventor: Jen-Hsuen Huang, Pate City (TW)

Correspondence Address: RABIN & Berdo, PC, 1101 14TH STREET, NW, SUITE 500, WASHINGTON, DC, 20005, US

(21) Appl. No.: 11/084,109

(22) Filed: Mar. 21, 2005

(30) Foreign Application Priority Data
May 19, 2004 (TW) 93114178

(51) Int. Cl. A21C 5/08; B26D 5/00

(52) U.S. Cl. 83/358

(57) ABSTRACT

A blade server system comprising a system management unit, a blade server, and an isolation circuit is provided. The system management unit outputs a control signal. The blade server communicates with the system management unit according to a signal line. A communication signal is outputted by the signal line of the server blade system via the isolation circuit. The system management unit and the isolation circuit control the conductivity of signals, preventing signal interference which occurs when the server blade system is hot-plugged or is not operating normally to assure a normal operation of the server blade system.

This application claims the benefit of Taiwan application Serial No. 93114178, filed May 19, 2004, the subject matter of which is incorporated herein by reference.

### BACKGROUND OF THE INVENTION

1. Field of the Invention

The invention relates in general to a server system, and more particularly to a blade server system.

2. Description of the Related Art

The blade server system is different from ordinary server system in that the blade server system comprises several blade servers. The server blade system integrates the hardware of a server system such as processor, memory, and hard disc into a single motherboard, and the several blade servers of a server blade system share the resources such as chassis, power supplier, keyboard, monitor and mouse.

Referring to FIG. 1, a block diagram of a conventional blade server system is shown. The blade server 102 is a blade server of the system, and all signal lines of all blade servers are electrically connected with the bus 106. The blade server outputs several communication signals to the bus 106 via several signal lines, then the system management unit 104 receives these signals at the bus 106.

Referring to FIG. 2, an overall structure diagram of a blade server system is shown. When the server blade system 200 is operating normally, the blade server 102 can be “hot plugged”, that is, it can be directly unplugged from or plugged into the connector 204. When the blade server 102 is hot plugged when still operating, a surge current will occur. The surge current not only prevents the bus 106 from operating normally but also affects the data transmission of other operating blade servers.

When the blade server 102 is not operating normally, the communication signal will always hold the voltage level of the bus 106, affecting the normal operation of the bus 106 and the data transmission of other operating blade servers.

### SUMMARY OF THE INVENTION

It is therefore an object of the invention to provide a blade server system. The server blade system isolates the interfering signal caused by a blade server hot-plugged or not operating normally, so that the server blade system is not affected by the signal interference and the stability of the server blade system can be maintained.

The invention achieves the above-identified object by providing a blade server system, comprising a system management unit for outputting a control signal, a blade server having a signal line for outputting a communication signal, and an isolation circuit coupled with the signal line and controlled by the control signal.

When the blade server is operating normally, the isolation circuit electrically connects the blade server to the system management unit, such that the signal line outputs a communication signal to the system management unit via the isolation circuit. When the blade server is not operating normally or is hot plugged, the isolation circuit does not electrical connect the blade server to the server blade system, such that the communication signal can not be outputted to the system management unit. Consequently, the signal isolation can be achieved and the overall system continues to have a normal operation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional blade server system;

FIG. 2 is an overall structure diagram of a blade server system;

FIG. 3 is a block diagram of a blade server system according to a preferred embodiment of the invention;

FIG. 4 is an example of an isolation device used in the blade server system of the invention in FIG. 3;

FIG. 5 is another example of an isolation device used in the blade server system of the invention in FIG. 3; and

FIG. 6 is an overall structure diagram of a blade server system according to a preferred embodiment of the invention.

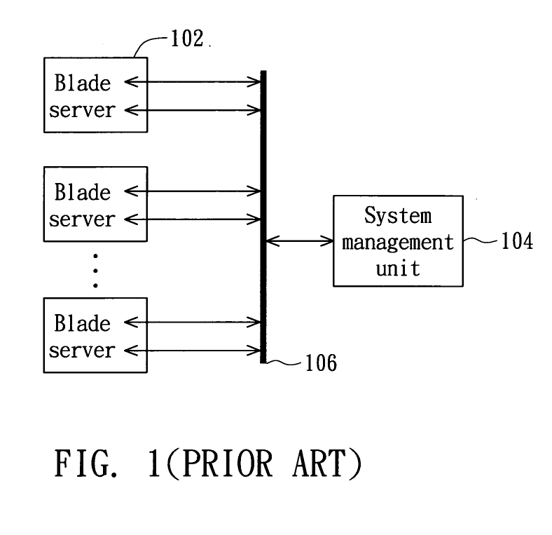

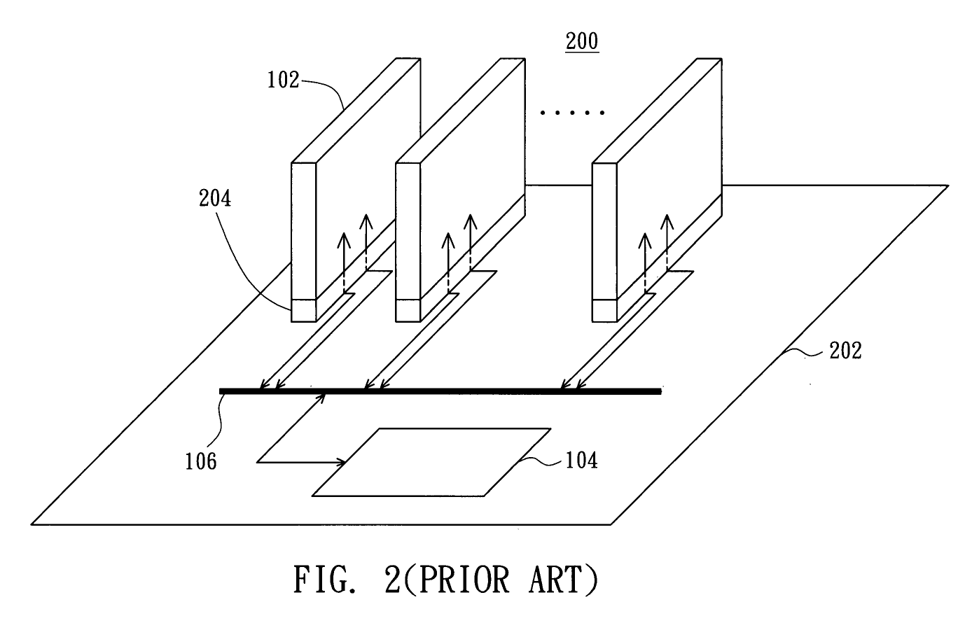

### DETAILED DESCRIPTION OF THE INVENTION

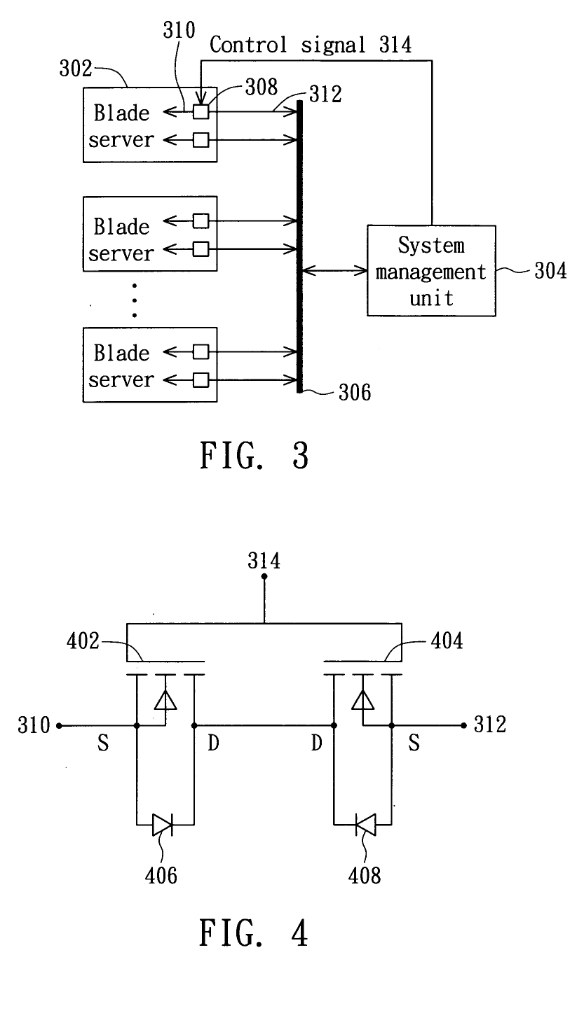

Referring to FIG. 3, a block diagram of a blade server system according to a preferred embodiment of the invention is provided. The blade server system comprises a system management unit 304, a blade server 302, and an isolation circuit 308. The blade server 302 has a signal line 310 via which a communication signal 312 is outputted. The isolation circuit 308 is coupled with the signal line 310 and is controlled by a control signal 314. The system management unit 304 obtains the status of the blade server 302 by the bus 306 the communication signal 312 transmitted to, and outputs a control signal 314 accordingly.

The isolation circuit 308 is disposed in the blade server 302 and controlled by the control signal 314 outputted from the system management unit 304. When the blade server 302 is operating normally, the isolation circuit 308 electrically connects the blade server 302 to the system management unit 304, the signal line 310 outputs the communication signal 312 to the system management unit 304 via the isolation circuit 308. When the blade server 302 is not operating normally or is hot plugged, the isolation circuit 308 does not electrically connect the blade server 302 to the system management unit 304, such that the communication signal can not be outputted to the system management unit 304. The specification of signal line 310 of the blade server 302 is an inter-integrated circuit bus (12C) or a communications port (COM).

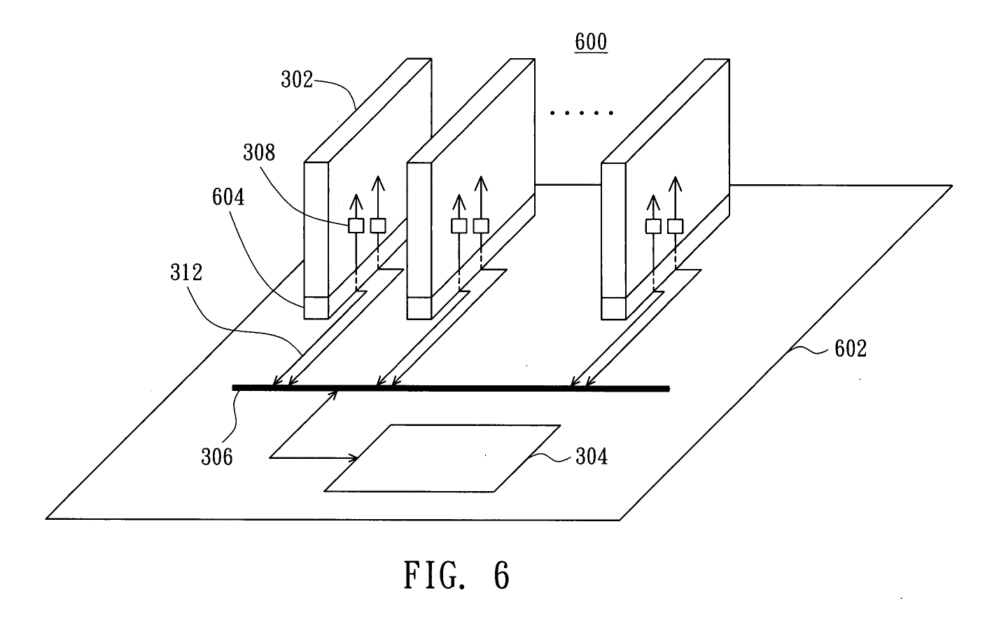

Referring to FIG. 6, an overall structure diagram of a server blade system according to a preferred embodiment of the invention is shown. The server blade system 600 further has a central circuit board 602, on which at least one connector 604 and a bus 306 are disposed. The blade server 302 is disposed on the central circuit board 602 via the connector 604 and is electrically connected with the system management 304 via the connector 604. The blade server 302 outputs the communication signal 312 to the system management unit 304 via the isolation circuit 308 and the bus 306.

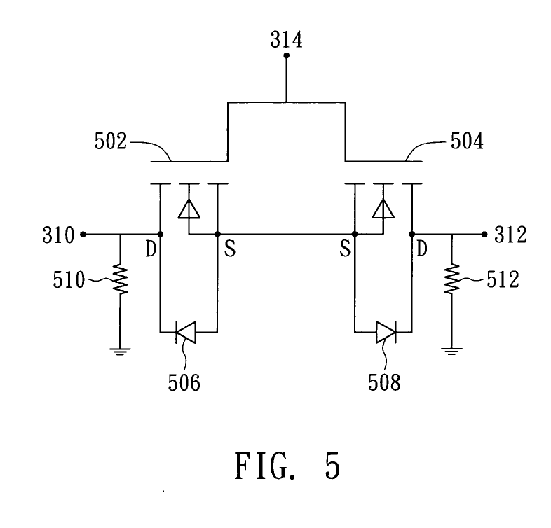

In the present embodiment, the isolation circuit 308 comprises two NMOS transistors and two diodes for example. Referring to FIG. 4, an example of an isolation device 308 used in the server blade system of the invention in FIG. 3 is shown. The isolation circuit 308 comprises an NMOS transistor 402, an NMOS transistor 404, a diode 406, and a diode 408. The source of the NMOS transistor 402 is coupled with the signal line 310. The source of the NMOS transistor 404 is coupled with the communication signal 312. The drain of the NMOS transistor 402 is coupled with the drain of the NMOS transistor 404. The gate of the NMOS transistor 402 and the gate of the NMOS transistor 404 receive the control signal 314 outputted by system management unit 304.

The source of the NMOS transistor 402 is coupled with the P-polarity of the diode 406. The drain of the NMOS transistor 402 is coupled with the N-polarity of the diode 406. The source of the NMOS transistor 404 is coupled with the P-polarity of the diode 408. The drain of the NMOS transistor 404 is coupled with the N-polarity of the diode 408. When the blade server 302 is disposed on the central circuit board 602 via connector 604, the source of the NMOS transistor 404 is electrically connected with the bus 306.

When the blade server 302 is operating normally, the system management unit 304 obtains the status of the blade server 302 via signal line 310, then uses the control signal 314 to control the isolation circuit 308. Meanwhile, the control signal adjusts the gate voltage (VG) of the NMOS transistor 402 and the gate voltage of the NMOS transistor 404, so that the relationship between the gate voltage (VG), the source voltage (VS), the gate/source voltage difference (VGS), and the threshold voltage (VT) is formed as follows:
VG−VS=VGS>VT;

Meanwhile, a channel is formed between the drain and the source, enabling the isolation circuit 308 to electrically connect the blade server 302 to the system management unit 304.

When the blade server 302 is operating abnormally or is hot-plugged, the system management unit 304 obtains the status of the blade server 302 via the signal line 310 then uses the control signal 314 to control the isolation circuit 308. Meanwhile, the control signal 314 adjusts the gate voltage of the NMOS transistor 402 and the gate voltage of the NMOS transistor 404, so that the relationship between the gate voltage, the source voltage, the gate/source voltage difference, and the threshold voltage is formed as follows:
VG−VS=VGS<VT;

Meanwhile, the channel between the drain and the source is closed, so that the isolation circuit 308 does not electrically connect the blade server 302 to the system management unit 304. Meanwhile, the input end and the output end of the isolation circuit 308 are in an isolation status, so as to achieve the object of isolating interfering signals.

Referring to FIG. 5, another example of an isolation device 308 used in the server blade system of the invention in FIG. 3. The isolation circuit 308 comprises two NMOS transistors, two diodes and two resistors. The isolation circuit 308 comprises an NMOS transistor 502, an NMOS transistor 504, a diode 506, a diode 508, a resistor 510, and a resistor 512. The drain of the NMOS transistor 502 is coupled with the signal line 310. The drain of the NMOS transistor 504 is connected to the communication signal 312. The source of the NMOS transistor 502 is coupled with the source of the NMOS transistor 504. The gate of the NMOS transistor 502 and the gate of the NMOS transistor 504 receive the control signal 314 outputted by the system management unit 304.

The source of the NMOS transistor 502 is coupled with the P-polarity of the diode 506. The drain of the NMOS transistor 502 is coupled with the N-polarity of the diode 506. The source of the NMOS transistor 504 is coupled with the P-polarity of the diode 508. The drain of the NMOS transistor 504 is coupled with the N-polarity of the diode 508. The drain of the NMOS transistor 502 is coupled with the one end of the resistor 510, and another end of the resistor 510 is grounded. The drain of the NMOS transistor 504 is coupled with the one end of the resistor 512, and another end of the resistor 512 is grounded.

When the blade server 302 is operating normally, the system management unit 304 obtains the status of the blade server 302 via signal line 310, then uses the control signal 314 to control the isolation circuit 308. Meanwhile, the control signal 314 adjusts the gate voltage of the NMOS transistor 502 and the gate voltage of the NMOS transistor 504, so that the relationship between the gate voltage, the source voltage, the gate/source voltage difference, and the threshold voltage is formed as follows:
VG−VS=VGS>VT;

Meanwhile, a channel is formed between the drain and the source, enabling the isolation circuit 308 to electrically connect the blade server 302 to the system management unit 304.

When the blade server 302 is operating abnormally or is hot-plugged, the system management unit 304 obtains the status of the blade server 302 via signal line 310 then uses the control signal 314 to control the isolation circuit 308. Meanwhile, control signal 314 adjusts the gate voltage of the NMOS transistor 502 and the gate voltage of the NMOS transistor 504, so that the relationship between the gate voltage, the source voltage, the gate/source voltage difference, and the threshold voltage is formed as follows:
VG−VS=VGS<VT;

Meanwhile, the channel between the drain and the source is closed, so that the isolation circuit 308 does not electrically connect the blade server 302 to the system management unit 304. Meanwhile, the input end and the output end of the isolation circuit 308 are in an isolation status, so as to achieve the object of isolating interfering signals.

The decentralized signal isolation device disclosed in above embodiments is applicable to server blade systems. When one particular blade server of a server blade system is hot-plugged or is operating abnormally, the invention can effectively isolate signal interference in the server blade system, so the server blade system can continue its normal operation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A blade server system, comprising
a system management unit for outputting a control signal;
a blade server having a signal line, wherein the signal line is for outputting a communication signal; and
an isolation circuit coupled with the signal line, wherein the isolation circuit is controlled by the control signal;
when the blade server is operating normally, the isolation circuit electrically connects the blade server to the system management unit, the signal line outputs the communication signal to the system management unit via the isolation circuit, but when the blade server is not operating normally or is hot plugged, the isolation circuit does not electrically connect the blade server to the system management unit and the communication signal can not be outputted to the system management unit.

2. The blade server system according to claim 1, wherein the isolation circuit is disposed in the blade server.

3. The blade server system according to claim 2, wherein the server blade system further has a central circuit board having a connector, and the blade server is disposed on the central circuit board via the connector to be electrically connected with the system management unit.

4. The blade server system according to claim 3, wherein the central circuit board has a bus, the communication signal are outputted to the system management unit via the isolation circuit and the bus.

5. The blade server system according to claim 4, wherein the isolation circuit comprises:
a first NMOS transistor, wherein the source of the first NMOS transistor is coupled with the signal line, the gate of the first NMOS transistor receives the control signal outputted by the system management unit; and
a second NMOS transistor, wherein the drain of the second NMOS transistor is coupled with the drain of the first NMOS transistor, the gate of the second NMOS transistor receives the control signal outputted by the system management unit, when the blade server is disposed on the central circuit board via connector, the source of the second NMOS transistor is electrically connected with the bus.

6. The blade server system according to claim 5, wherein the isolation circuit further comprises a first diode and a second diode, the source of the first NMOS transistor is coupled with the P-polarity of the first diode, the drain of the first NMOS transistor is coupled with the N-polarity of the first diode, the source of the second NMOS transistor is coupled with the P-polarity of the second diode, the drain of the second NMOS transistor is coupled with the N-polarity of the second diode.

7. The blade server system according to claim 3, wherein the isolation circuit comprises:
a first resistor and a second resistor, wherein a first end of the first resistor is grounded, and a first end of the second the resistor is grounded;
a third NMOS transistor, wherein the third drain of the NMOS transistor is coupled with the signal line and is coupled with a second end of the first resistor, the gate of the third NMOS transistor receives the control signal outputted by the system management unit; and
a fourth NMOS transistor, wherein the fourth source of the NMOS transistor is coupled with the source of the third NMOS transistor, and the drain of the fourth NMOS transistor is coupled with a second end of the second resistor, when the blade server is disposed on the central circuit board via the connector, the drain of the fourth NMOS transistor is electrically connected with the bus, the gate of the fourth NMOS transistor receives the control signal outputted by the system management unit.

8. The blade server system according to claim 7, wherein the isolation circuit further comprises a third diode and a fourth diodes, the source of the third NMOS transistor is coupled with the P-polarity of the third diode, the drain of the third NMOS transistor is coupled with the N-polarity of the third diode, the source of the fourth NMOS transistor is coupled with the P-polarity of the fourth diode, the drain of the fourth NMOS transistor is coupled with the N-polarity of the fourth diode.

9. The blade server system according to claim 1, wherein the signal line complies with inter-integrated circuit bus specification (12C) or communications port (COM) specification.
